(19) United States
(12) Patent Application Publication
(10) Pub. No.: US 2005/0238187 A1
(43) Pub. Date: Oct. 27, 2005

(54) Loudspeaker with inverted cone

(75) Inventor: Jozef Arnold Frans Baeten, Dendermonde (BE)

Correspondence Address: PHILIPS INTELLECTUAL PROPERTY & STANDARDS, P.O. BOX 3001, BRIARCLIFF MANOR, NY, 10510, US

(73) Assignee: KONINKLJKE PHILIPS ELECTRONICS, N.V., EINDHOVEN (NL)

(21) Appl. No.: 10/524,401

(22) PCT Filed: Jul. 31, 2003
(86) PCT No.: PCT/IB03/03402

§ 371 Date: Feb. 11, 2005

(30) Foreign Application Priority Data
Aug. 16, 2002 (EP) 02078392.4

(51) Int. Cl. H04R 25/00

(52) U.S. Cl. 381/150

(57) ABSTRACT

An electrodynamic loudspeaker comprising a chassis (2), a movable body (4) flexibly connected to the chassis and having a three-dimensional diaphragm (8) with a base part (8b) and a top part (8a) which is wider than the base part, and an electromagnetic actuator (6) for moving said body with respect to the chassis along a translation axis (10) extending between said two parts of the diaphragm. The actuator comprises a stationary actuator part (6a) secured to the chassis and a translatable actuator part (6b), which substantially extends inside the space (9) enveloped by the contours of the diaphragm and which is translatable along the translation axis with respect to the stationary actuator part and is connected to the movable body in the region of the base part of the diaphragm. The actuator parts are capable of magnetically co-operating with each other across an air gap (16). In order to obtain a small building-in depth, the movable body comprises, in the proximity of the base plate of the diaphragm, a bridging element (22) secured to the movable part of the actuator. This element extends radially with respect to the translation axis, and the diaphragm and the bridging element are interconnected at a radial distance to the translatable part of the actuator.

The invention relates to an electrodynamic loudspeaker comprising a chassis, a movable body flexibly connected to the chassis and having a three-dimensional diaphragm with a base part and a top part which is wider than the base part, and an electromagnetic actuator for moving said body with respect to the chassis along a translation axis extending between said two parts of the diaphragm, which actuator comprises a stationary actuator part secured to the chassis and a translatable actuator part, which latter part substantially extends inside the space enveloped by the contours of the diaphragm and which latter part is translatable along the translation axis with respect to the stationary actuator part and is connected to the movable body in the region of the base part of the diaphragm, said actuator parts being capable of magnetically co-operating with each other across an air gap. Thus the invention relates to a so-called inverted loudspeaker.

GB-A 2 360 849 discloses an inverted coaxial speaker for use in automobile doors and similar thin structures. This known speaker has a frame, an electromagnetic actuator, and a frustoconical speaker cone. This cone has an outer perimeter secured via a roll section to the frame and an inner perimeter secured to one end of a cylindrical coil former of the actuator, a flexible corrugated suspension member extending between this end and the frame. The other end of the coil former extends into an annular gap of an magnetic yoke fixed to the frame and carries a voice coil.

Although the known inverted speaker has a smaller axial dimension than generally known conventional speakers in which the actuator is situated behind a backplane of the speaker cone, the known inverted speaker has still a relatively great height owing to the required relatively long voice coil former.

It is an object of the invention to improve the loudspeaker as defined in the preamble in such a way that a very small height is within reach.

According to the invention, this object is achieved with the loudspeaker which is characterized in that the movable body comprises, in the proximity of the base part of the diaphragm, a bridging element which is secured to the movable part of the actuator and extends radially with respect to the translation axis, the diaphragm and the bridging element being interconnected at least at a radial distance to the translatable part of the actuator.

Due to the characteristic features described above, the base part of the diaphragm needs not to be fastened to the translatable part of the actuator, but is secured to the bridging element and is thus indirectly connected to the translatable part. In consequence of this, the width of the base part is greater than the corresponding dimension of the translatable part of the actuator. This renders it possible to shorten the translatable part of the actuator with respect to the length of the coil former of the inverted speaker disclosed in the above-mentioned GB-A 2 360 899 without reducing the effective axial displacement possibility of the movable body. This means that the coaxial loudspeaker according to the invention has a ratio between the height of the construction and the stroke of the movable part thereof which is very suitable for high-performance applications in structures of limited depth. In other words, the loudspeaker has only a limited axial dimension in spite of its three-dimensional diaphragm, so that it has a small building-in depth. The speaker is eminently suitable for use in subwoofer systems in which compact, shallow housings are desired or even required. Such conditions are plentifully present in the automotive field, where speakers are mounted into e.g. car doors and dashboards and even under seats.

It is preferred to provide the loudspeaker according to the invention with both a first flexible connecting means proximate to the top part of the diaphragm and a second flexible connecting means proximate to the base part of the diaphragm for movably supporting the translatable body with respect to the chassis. Preferably, the first connecting means is fixed to the chassis and the diaphragm, and the second connecting means is fixed to the chassis and the bridging element.

It is noted that an additional drawback of the speaker disclosed in the above-mentioned GB-A 2 360 899 is that the limited available space within the diaphragm makes it difficult to build a powerful electromagnetic actuator which complies with high load requirements. Particularly the thermal load of the magnetic material of the magnetic structure of the actuator is a limiting factor. Notably with modern magnetic materials, such as neodymium-iron-boron alloys, the maximum allowable temperatures are relatively low.

This drawback can be removed or at least substantially reduced in the loudspeaker according to the invention if the bridging element is designed such that it functions as a cooling element during operation. In this context a thermally conductive material, such as a metal, e.g. aluminum, is an essential parameter. An embodiment of the loudspeaker in accordance with the invention has the feature that the bridging element is a thermally conductive disc-shaped element. Due to the direct connection between the movable part of the actuator and the disc-shaped bridging element, heat generated in the actuator during operation is given off to the surroundings via the disc-shaped element. Consequently, the temperature in the actuator remains relatively low during use. It has been found that the temperature remains within limits, set for the use of modern magnetic materials, even in the case of high powers.

In a practical embodiment of the loudspeaker according to the invention, the stationary actuator part comprises a magnetic structure and the translatable actuator part comprises a magnetic coil—also referred to as voice coil—, the magnetic coil extending into the air gap. The magnetic structure comprises a permanent magnet and usually a soft-magnetic yoke. During operation, an electrical current is flowing through the coil for generating, in co-operation with the magnetic field of the permanent magnet, an axial force for driving the movable body. It is inevitable that the electrical current also generates heat in the coil. However, if use is made of the cooling element of the kind described above, the coil temperature remains relatively low—also in the case of high loads—and only a limited transfer of heat to the other parts of the actuator, such as the permanent magnet, takes place. Thus a favorable thermal balance is warranted. This offers, moreover, the opportunity to make use of a multilayer voice coil in order to realize high BL-values, in spite of a limited coil diameter. As it is assumed that the term BL-value is generally known to those skilled in those art, the term is not explained here. Reference is made e.g. to Leo L. Beranek, Acoustics, ISBN 0-88318-494-X, pages 70 to 75.

In another embodiment of the loudspeaker, the disc-shaped element is provided with at least one tuning opening. Such an opening or openings may be used for tuning the mass of the entire movable structure of the loudspeaker. This relatively easy tuning widens the manufacturing tolerances for the other components of the movable structure, particularly the diaphragm, and thus reduces the manufacturing cost of the loudspeaker. The tuning opening or openings may also be used for tuning the mechanical Q-factor of the actuator. It is also assumed that this factor, which is related to the counteracting mechanical forces of the construction, is generally known to those skilled in the art, and for this reason the Q-factor is not explained here. Reference is made e.g. to Leo L. Beranek, Acoustics, ISBN 0-8831-8494-X pages 183 to 200. The friction resistance acting on the bridging element during operation can be adjusted so as to improve the Q-factor, in dependence on the size of the tuning opening or openings.

An embodiment of the loudspeaker is characterized in that the cooling element has an anodized cooling surface. This feature gives the cooling element an improved heat-radiating capacity. A suitable metal for the cooling element is aluminum.

The invention also relates to a loudspeaker unit comprising the electrodynamic loudspeaker according to the invention and a housing accommodating the loudspeaker. The loudspeaker unit may form part of a compact subwoofer system in which the loudspeaker can be subjected to a high load. The loudspeaker according to the invention occupies only a limited space in the housing, which maybe formed by a car door or portion thereof or by another suitable mechanical structure of a car. High powers of the order of for example, about 300 watts are possible.

It is noted in relation to the claims that various combinations of characteristic features defined in the claims are possible.

The above-mentioned and other aspects of the invention are apparent from and are elucidated, by way of non-limitative examples, with reference to the embodiments described hereinafter.

In the drawings:

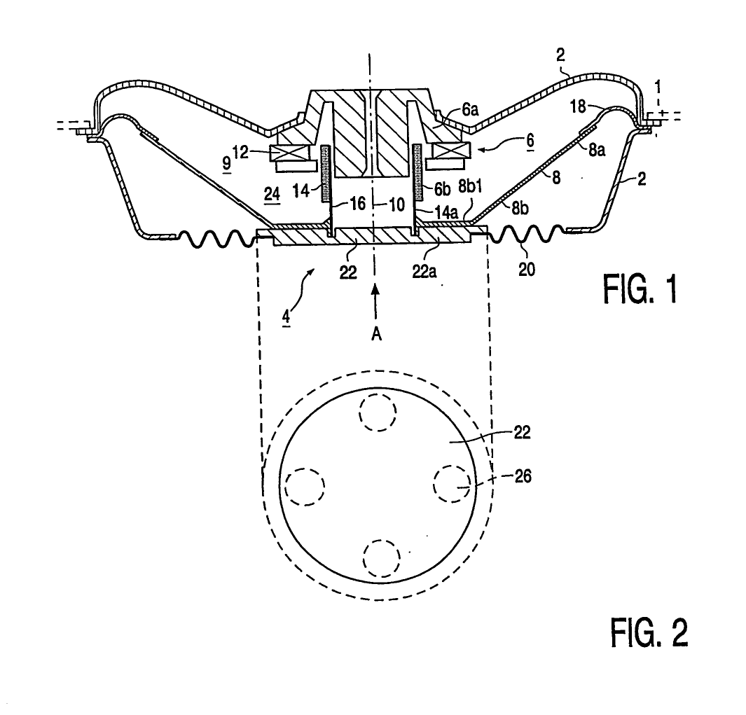

FIG. 1 shows an embodiment of the loudspeaker according to the invention in a diagrammatic cross-section,

FIG. 2 is a view taken along arrow A of an essential component of the loudspeaker shown in FIG. 1, and

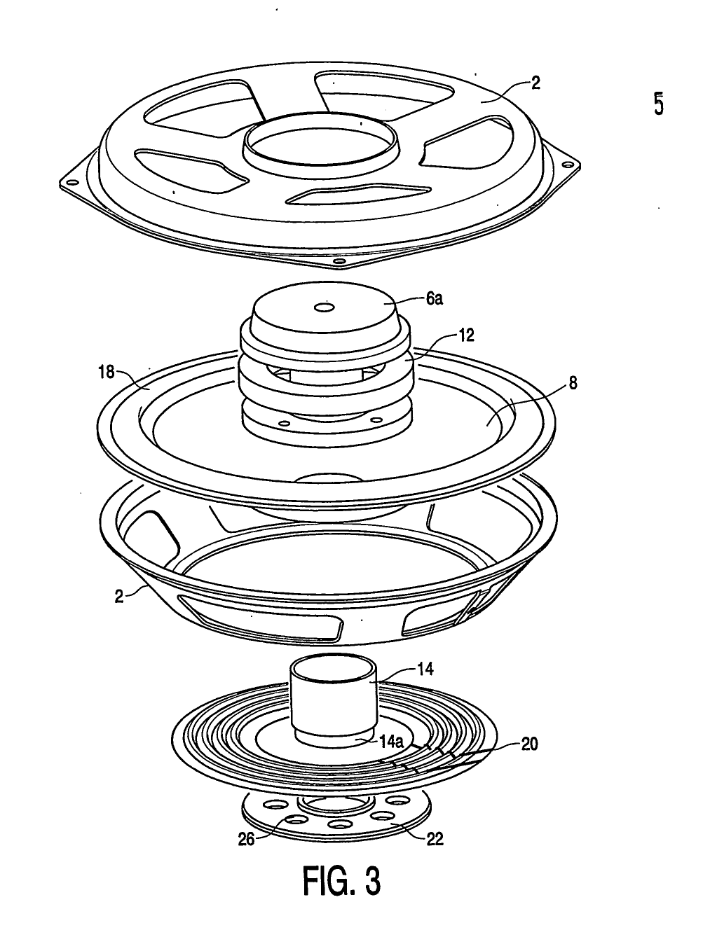

FIG. 3 is a perspective exploded view of the loudspeaker of FIG. 1.

The electrodynamic loudspeaker according to the invention shown in the Figures comprises a chassis 2, in this example comprising two chassis parts, a movable body 4, and an electromagnetic actuator 6. For forming a loudspeaker unit according to the invention, the loudspeaker may be accommodated in a housing. To this end, the chassis 2 of the loudspeaker may be fixed in an appropriate opening in a wall of the housing. In FIG. 1, the housing is shown diagrammatically as a wall section 1 in broken lines. The translatable body 4 comprises a three-dimensional diaphragm 8, in this example a conical diaphragm, which is situated at least partly in the chassis 2. The diaphragm 8 has a relatively wide top part 8a and a relatively narrow base part 8b. The contours of the diaphragm bound and define an inner space 9. The function of the electromagnetic actuator 6 is to displace the body 4 along a translation axis 10, which is the central axis of the loudspeaker and extends in a direction from the top part 8a to the base part 8b, or vice versa

The actuator 6 essentially comprises two elements, namely a stationary actuator part 6a which is fixed to the chassis 2 and a translatable actuator part 6b which is connected to the translatable body 4 and is situated in or at least mainly in the space 9 enveloped by the contours of the diaphragm 8. One of the actuator parts—in this example the part 6a—is provided with a permanent magnet 12, in this example annular in shape and axially polarized, and the other actuator part—in this example the part 6b—is provided with a magnet coil 14. When the coil 14 is energized, the two actuator parts 6a, 6b magnetically cooperate with each other across an air gap 16 for generating a driving force on the translatable body 4 parallel to the translation axis 10 and hence on the diaphragm 8 forming part thereof. The permanent magnet 12 is formed from an neodymium-iron-boron alloy and forms a magnetic yoke with soft iron portions of the stationary actuator part 6a, which yoke defines the air gap 16 in this example. The magnet coil 14, being a cylindrical coil, also referred to as voice coil, is situated on a coil support 14a, which is a sleeve in this example and is fixed to the translatable body 4.

The depicted coaxial loudspeaker is provided with a flexible connection for the translatable body 4 and hence for the diaphragm 8. This flexible connection comprises a first flexible connecting means 18 proximate to the top part 8a of the diaphragm 8 and a second flexible connecting means 20 proximate to the base part 8b of the diaphragm 8. The flexible connection is to ensure that the body 4, and thus the diaphragm 8, can perform well-defined translation movements with respect to the chassis 2.

The first flexible connection means 18 has a roll structure know per se and formed from, for example, a bent rubber or foam annular rim which is secured, for example glued, by its outer circumference to the chassis 2 and by its inner circumference to the membrane 8. In this example, the second flexible connecting means 20 has a flexible corrugated member known per se, which is secured by its outer circumference to the chassis 2.

The loudspeaker according to the invention is provided with a bridging element 22 secured to the coil support 14a of the translatable actuator part 6b. In the depicted example, the bridging element 22 is a disc-shaped element which is made for cooling purposes from a thermally well-conductive material, e.g. aluminum, copper. The plate-shaped bridging element 22 has been secured to the coil support 14a, by means of e.g. soldering, glueing or another suitable process. The bridging element 22 is perpendicularly oriented with respect to the translation axis 10 and hence with respect to the sleeve-shaped coil support 14a and thus extends in a radial direction with respect to the translation axis 10 and the coil support 14a The diaphragm 8 of the loudspeaker is shaped such that it can be fastened, e.g. glued, by its rim 8b1 to an edging section 22a of the bridging element 22.

Owing to this measure, the connection between the diaphragm 8 and the translatable actuator part 6b is effected via the bridging element 22, the fastening of the diaphragm 8 to the bridging element 22 being at a radial distance to the translatable actuator part 6b. This feature leads to favorable mutual positions of the diaphragm 8 and the stationary actuator part 6, in the sense that the space 24 between the rim 8a of the diaphragm 8 and the oppositely located portion of the stationary actuator part 6a can be optimally used for translating the actuator part 6b.

The second flexible connecting means 20 mentioned above is in this embodiment secured by its inner circumference to the edging section 22a of the bridging element 22.

As is shown in FIG. 2, the bridging element 22 may be optionally provided with tuning openings 26 for e.g. mass tuning and/or tuning of the Q-factor of the loudspeaker. In order to improve the cooling effect of the bridging element 22, the element 22 may have an anodized cooling surface.

It is to be noted that the invention is not limited to the embodiment shown. For example, the diaphragm may have a shape which differs from the cone shape. Moreover, the loudspeaker unit may not only comprise one or more loudspeakers according to the invention, but also one or more bass reflex ports and/or one or more passive radiators. Furthermore, the loudspeakers are not limited to a certain power.

1. An electrodynamic loudspeaker comprising a chassis, a movable body flexibly connected to the chassis and having a three-dimensional diaphragm with a base part and a top part which is wider than the base part, and an electromagnetic actuator for moving said body with respect to the chassis along a translation axis extending between said two parts of the diaphragm, which actuator comprises a stationary actuator part secured to the chassis and a translatable actuator part, which latter actuator part extends inside a space enveloped by the contours of the diaphragm and is translatable along the translation axis with respect to the stationary actuator part and is connected to the movable body in the region of the base part of the diaphragm, said actuator parts being capable of magnetically co-operating with each other across an air gap, wherein the movable body comprises, in the proximity of the base part of the diaphragm, a bridging element which is secured to the movable part of the actuator and extends radially with respect to the translation axis, the diaphragm and the bridging element being interconnected at least at a radial distance to the translatable part of the actuator.

2. A loudspeaker as claimed in claim 1, wherein the bridging element is designed such that it functions as a cooling element during operation.

3. A loudspeaker as claimed in claim 1, wherein the bridging element is a thermally conductive disc-shaped element.

4. A loudspeaker as claimed in claim 1, wherein the stationary actuator part comprises a magnetic structure and the translatable actuator part comprises a magnetic coil, said magnetic coil extending into the air gap.

5. A loudspeaker as claimed in claim 3, wherein the disc-shaped element is provided with at least one tuning opening.

6. A loudspeaker as claimed in claim 2, wherein the cooling element has an anodized cooling surface.

7. A loudspeaker as claimed in claim 1, wherein a first flexible connecting means is present proximate to the top part of the diaphragm and a second flexible connecting means is present proximate to the base part of the diaphragm for movably supporting the translatable body with respect to the chassis, and wherein the first flexible connecting means is fixed to the chassis and the diaphragm and the second flexible connecting means is fixed to the chassis and the bridging element.

8. A loudspeaker unit comprising the loudspeaker as claimed in claim 1 and comprising a housing accommodating the loudspeaker.
